(19) United States
(12) Patent Application Publication
(10) Pub. No.: US 2026/0170521 A1
(43) Pub. Date: Jun. 18, 2026

(54) Evaluating Variants in Online System Configuration by Applying a Machine-Learning Model to Simulations from Historical Interactions

(71) Applicant: Maplebear Inc., San Francisco, CA (US)

(72) Inventors: Vinesh Reddy Gudla, South San Francisco, CA (US); Prakash Putta, Seattle, WA (US)

(21) Appl. No.: 18/981,594

(22) Filed: Dec. 15, 2024

(51) Int. Cl. G06Q 30/0203; G06Q 30/0202

(52) U.S. Cl. CPC G06Q 30/0203; G06Q 30/0202

(57) ABSTRACT

An online system runs experiments to test one or more variants against a control. For example, a variant differently presents content to users compared to a control presentation. To prune variants that are unlikely to test well with users, the online system obtains data for each variant by simulating the variant for real user requests to the system based on historical user interactions. The online system then extracts statistical features about the simulated results for each variant to generate a quality score. Optionally, the online system applies a visual language model (VLM) to a simulated result for a variant when generating the quality score for the variant. The online system may apply a set of rules or a trained model to the extracted statistical features for a variant to determine whether to test the variant or prune it before testing.

### BACKGROUND

Various online systems present data to users and allow users to select one or more portions of the presented data. For example, an online system identifies one or more items available from one or more sources to a user via one or more interfaces. Through interaction with the one or more interfaces, the user selects one or more of the items. As another example, an online system receives a search query from a user, identifies one or more items that at least partially satisfy the search query, and presents the one or more items to the user via an interface.

Variations in how an online system generates or presents data to users affects how the users subsequently interact with the online system. For example, an online system modifying an order in which different items are presented to a user affects the items with which the user interacts or affects a frequency with which the user subsequently interacts with the online system. Similarly, changes in how the online system positions items relative to each other in an interface or changes to other visual features of one or more items in an interface affects a frequency or an amount with which the user subsequently interacts with the online system.

Over time, many online systems may modify generation of data for presentation to users. Because such modifications influence user interaction with the online systems, conventional online systems evaluate how various modifications to generation of data affect user interaction with the online system. Many online systems evaluate modifications to data generation by differently generating data presented to different subsets of users and analyzing changes in user interactions after being presented with different data. For example, an online system identifies a test subset of users and generates an alternative interface for users in the test subset, while continuing to generate a conventional interface for users outside of the test subset. Differences between user interactions with the alternative interface and with the conventional interface affect whether an online system subsequently presents the alternative interface or the conventional interface.

However, evaluating different variations in data generation involves significant computing resources for generating different data for different users. For example, an online system maintains different test subsets of users, and generates different interfaces for users in different test subsets to evaluate multiple interfaces. Further, identifying a test subset for different users introduces additional latency when generating data for users. Additionally, evaluating interactions by users in different test subsets increases an amount of time to evaluate different variations for generating data by relying on current interactions by users with differently generated data, which delays modification to data generation until the online system receives a sufficient amount of interactions from users presented with differently generated data.

### SUMMARY

Accordingly, while it is desirable to test one or more variants of a computer system, it is also desirable to avoid testing variants that are relatively unlikely to provide improved results over a control configuration. To avoid wasting computing resources on such poor quality variants, one or more embodiments use historical user interactions with the computer system to simulate how the computer system would have performed if it were using the variant instead of the control configuration. These results are then evaluated, and one or more of the variants are pruned and a remaining subset of variants are selected for testing against the control configuration. The computer system may then perform an experiment using the selected variants and the control configuration, such as A/B testing or a multi-arm bandit algorithm, where the system gathers data using each of the variants and performs a statistical analysis on their performance against one or more metrics. By pruning some of the variants before testing, the system reduces the computational burden of running the experiment and also requires fewer interactions with users using the variants, as such interactions often result in a worse user experience.

In accordance with one or more aspects of the disclosure, an online system uses a control configuration to generate data for presentation to one or more users in response to interactions received from users. The control configuration comprises instructions that, when executed by the online system, select data and format data for presentation to a user. For example, the control configuration specifies how the online system ranks or selects data for presentation to a user in response to an interaction from the user. As another example, the control configuration specifies how the online system displays different data to a user in response to an interaction from the user. Hence, the control configuration comprises instructions specifying generation of data in response to receiving an interaction from the user by the online system. For example, the control configuration specifies how the online system generates an interface presenting search results based on a search query. In an example, the control configuration specifies how the online system ranks search results or how the online system displays search results relative to each other in an interface.

Data generated based on the control configuration affects subsequent interaction by users with the online system. For example, relevance of items the control configuration selects as search results for a search query received from a user increases or decreases an amount of subsequent interaction by the user with the online system. If the control configuration generates search results having a larger number of items relevant to a search query and more visible in an interface to a user, the user is more likely to select one or more of the items or to subsequently provide additional search queries to the online system. Conversely, if the control configuration generates search results having a smaller number of items that are relevant to a search query from a user or presents items having higher relevance to the search query in less visible positions in an interface, the user is less likely to select one or more of the items or to subsequently provide additional search queries to the online system.

Additionally, as users interact with the online system, the online system stores the received interactions to maintain a record of historical interactions by users with the online system. In various embodiments, the online system stores an identifier of a user and a type of interaction for a historical interaction. The online system stores contextual information in association with an interaction in various embodiments. Example contextual information includes a time when the online system received an interaction, a location associated with a user from whom the interaction was received, an identifier of a source (e.g., a source of items, a source of content) associated with the interaction. Additional or alternative contextual information may be stored in association with interactions in various embodiments. In some embodiments, the online system also stores data generated in response to a historical interaction in association with the historical interaction. For example, the online system stores an interface generated in response to an interaction in association with the interaction. As another example, the online system stores descriptive information about data generated in response to an interaction, such as attributes of items selected based on the control configuration in response to an interaction or information describing presentation of items in response to the interaction.

Because data generated based on the control configuration affects subsequent user interaction with the online system, modifying the control configuration influences how users interact with the online system over time. For example, modifying how an interface presents data based on the control configuration may increase a frequency with which a user interacts with the online system or may increase a frequency with which the user selects data included in the generated interface. However, alternative modifications to the control configuration may decrease subsequent user interaction with the online system, so the online system evaluates effects on user interaction with the online system prior to performing one or more modifications to the control configuration.

An alternative configuration for the online system to generate content is referred to herein as a “variant.” Modifications to the control configuration evaluated for subsequent content generation are variants of the control configuration. A variant includes one or more differences from the control configuration. For example, a variant modifies an order in which items are ranked by the online system or modifies how one or more items are displayed in an interface by the online system relative to the control configuration. However, in other embodiments, a variant has different or additional differences from the control configuration. The online system determines one or more variants from the control configuration for evaluation, with different variants representing different modifications to the control configuration.

To evaluate whether to generate data using a variant, the online system retrieves a set of historical interactions. In various embodiments, the online system also retrieves contextual information associated with the historical interactions. The set of historical interactions includes historical interactions having different contextual information, such as different types of historical interactions, different association locations, or other differing contextual information. Retrieving contextual information associated with a historical interaction obtains additional descriptive information about when a historical interaction was received and descriptive information about one or more sources used to generate data in response to the historical interaction.

Based on a historical interaction, the online system generates evaluation data for the variant. The evaluation data comprises data generated by the online system using the variant in response to the historical interaction. Hence, the evaluation data indicates how the online system would have generated data in response to the historical interaction using the variant. In various embodiments, the online system retrieves a set of data corresponding to the contextual information associated with a historical interaction and generates data based on the retrieved set of data and the historical interaction using the variant. For example, the online system selects a subset of items from the retrieved data based on the historical interaction and generates a ranking of the subset of items based on the variant. The evaluation data comprises an interface displaying the subset of items in the ranking based on the variant in various embodiments.

Additionally, the online system obtains an interface generated using the control configuration in response to the historical interaction. In some embodiments, the online system retrieves the contextual information associated with the historical interaction, retrieves a set of data based on the contextual information, and generates the interface from the set of data using the historical interaction and the control configuration. As another example, the online system retrieves an interface stored in association with the historical interaction when the historical interaction was initially received by the online system. Obtaining the interface generated using the control configuration allows comparison of the interface generated for the historical interaction based on the control configuration to the evaluation data generated for the historical interaction based on the variant.

Based on the evaluation data for the historical interaction, the online system generates a quality score for the variant. In various embodiments, the online system generates one or more metrics based on the evaluation data for variants as the quality score. As another example, the online system generates the quality score based on differences between metrics based on the evaluation data and metrics based on the interface generated based on the control configuration. For example, the one or more metrics provide measures of effects of differences between likelihoods of users interaction with the evaluation data and with the interface generated based on the control configuration on user interaction. For example, a metric comprises a measure of precision of items retrieved by the online system for the historical interaction based on the variant. An additional or alternative metric comprises a normalized discounted cumulative gain of a ranking of items in evaluation data based on the variant. However, in other embodiments, the online system generates one or more additional or alternative metrics for variant based on the evaluation data.

In various embodiments, the online system also determines the metrics for the interface based on the control configuration generated in response to the historical interaction, allowing comparison of the metrics for the variant to the metrics for the control configuration. For example, the one or more metrics for the interface generated based on the control configuration may be used as threshold values for the quality score. As another example, the online system generates the quality score based on differences between metrics for the evaluation data and corresponding metrics for the interface generated using the control configuration. In some embodiments, the quality score for the variant comprises a set of metrics generated based on the evaluation data for the variant. However, in other embodiments, the online system combines one or more metrics generated based on the evaluation data into a single quantity comprising the quality score for variant.

In various embodiments, the online system also applies a visual language model (VLM) to the interface and to the evaluation data. The VLM generates text describing one or more visual features describing differences between evaluation data and data generated using the control configuration. The VLM comprises a multimodal generative model that receives one or more images and text data as input. The VLM generates an output based on the received images and text data. For example, the VLM generates text data based on the received images and text data. In various embodiments, the VLM generates text data describing differences between different images received as input. For example, the VLM receives the interface generated based on the control configuration, the evaluation data, and a prompt to identify differences between the interface generated based on the control configuration and the evaluation data as input. In response to the input, the VLM generates text describing one or more visual features that are differences between data generated for the historical interaction using the control configuration and the evaluation data generated for the historical interaction using the variant. For example, the visual features comprise text describing differences between presentation of data in the data generated based on the control configuration and in the evaluation data. For example, the visual features identify differences in positions of items in the data generated based on the control configuration and in the evaluation data or differences in visual presentation of items in the data generated based on the control configuration and presentation of items in the evaluation data.

The VLM also generates an evaluation score for variant based on changes between the evaluation data and the interface in various embodiments. For example, the evaluation score comprises an indication whether the evaluation data is more relevant to a user than the data generated using the control configuration. For example, the evaluation score has a first value in response to the VLM determining the evaluation data is more relevant to the user than the data generated based on the control configuration and has a second value in response to the VLM determining the evaluation data is less relevant to the user than the data generated based on the control configuration. The evaluation score may have an alternative value in response to the VLM determining the evaluation data and the data generated based on the control configuration are equally relevant to users. The evaluation score accounts for contextual information associated with the particular historical interaction, allowing the VLM to account for variations between different historical interactions (e.g., different users, different locations, different types of historical interactions, etc.) when generating the evaluation score.

In various embodiments, the quality score includes one or more metrics generated as further described above and the evaluation score generated by the VLM. Alternatively, the online system combines the one or more metrics and the evaluation score into a single quantity comprising the quality score. In some embodiments, the quality score includes the one or more metrics and one or more visual features generated from the VLM. Hence, the quality score for the variant accounts for statistical evaluation of the evaluation data from the one or more metrics, as well as the evaluation score from the VLM comparing the evaluation data to the data generated based on the control configuration.

The online system determines a quality score for the variant for different historical interactions and determines the quality score for variant based on the different interaction-specific quality scores for different historical interactions in various embodiments. For example, the online system determines a quality score for the variant for each of a set of historical interactions and determines the quality score for the variant as an average, or other statistical quantity, based on interaction-specific quality scores for each of the historical interactions of the set. Hence, the quality score for the variant provides a measure of changes between the evaluation data and the data generated based on the control configuration. In various embodiments, the quality score is based on a difference between expected relevance of the evaluation data and of the data generated based on the control configuration to users or based on a difference between expected interaction by users with data included in the evaluation data and with the data generated based on the control configuration.

Leveraging the stored historical interactions to generate data for one or more historical interactions using the control configuration and to generate evaluation data for one or more historical interactions using the variant enables evaluation of differences in data generated using the control configuration and using the variant. Using historical interactions previously received from users allows initial evaluation of the variant without expending computational resources to generate data in response to recently received interactions from users based on the variant. Additionally, using the control configuration to generate data for newly received interactions from users, while generating a quality score for the variant based on historical interactions, allows the online system to evaluate the variant without expending computational resources to generate data for newly received interactions using both the control configuration and the variant.

While the quality score for variant provides an initial measure of effectiveness of the variant before modifying the control configuration to the variant, the online system obtains further information about user interaction with data generated by the variant based on additional interactions that are newly received from users. For example, the online system generates data using the variant for interactions received from a subset of users, while generating data using the control configuration for interactions received from other users. As generating data differently for different users increases computational resources expended to present data, the online system uses the quality score for the variant to determine whether to use the variant to generate data for additionally received interactions.

To reduce computational resources used to evaluate the variant against the control configuration, the online system determines whether the quality score for the variant satisfies at least a threshold amount of criteria. In response to determining that the quality score does not satisfy at least the threshold amount of criteria, the online system prevents use of the variant in an experiment by preventing future generation of content using the variant in response to additional user interactions. In one or more embodiments, the online system maintains a set of rules to which the quality score is compared. For example, different rules specify different threshold values for one or more metrics comprising the quality score. In response to the online system determining the quality score does not satisfy at least a threshold amount of rules (e.g., a threshold amount of metrics comprising the quality score are less than corresponding threshold values specified by rules), the online system prevents use of the variant for generating data for additional interactions. In an example, a set of rules includes threshold values for each of one or more metrics and a threshold evaluation score for the evaluation score generated by the VLM. In response to determining the quality score includes at least a threshold amount of metrics with values less than corresponding threshold values and includes an evaluation score less than the threshold evaluation score, the online system prunes the variant from the set of variants to be used later for testing. For example, the online system may prune the variant by preventing generation of data using the variant during the subsequent testing. In other embodiments, the online system prevents generation of data using the variant in response to one or more specific metrics included in the quality score being less than corresponding threshold values.

Alternatively, the online system applies an assessment model to variant and the quality score for variant. The assessment model generates a probability of generating data using the variant based on the quality score for the variant. The assessment model may be trained through a backpropagation process using training examples. Each training example includes a training variant and a corresponding training quality score; further, each training example has a label indicating whether a training variant was used to generate content in response to interactions from users. In response to the probability of generating data for the variant from the assessment model being less than a threshold probability, the online system prevents generation of data in response to additional interactions from users based on the variant.

In contrast, for variants that have a quality score that satisfies at least the threshold amount of criteria, the online system selects those variants to be used for an experiment. During the experiment, the online system generates data based on these variants in response to additional interactions from users. For example, the online system generates data based on the variant in response to the probability from the assessment model equaling or exceeding the threshold probability. In various embodiments, the online system generates data based on the variant in response to additional interactions received from a subset of users, while generating data based on the control configuration in response to additional interactions from other users. This allows the online system to further evaluate user responses to data generated based on the variant against user responses to data generated based on the control configuration.

Limiting generation of data for additional interactions from users to variants having quality scores satisfying at least the threshold amount of criteria limits a number of variants used to generate data during the experiment. Reducing the number of variants for generating content conserves computing resources the online system uses to generate data in response to interactions from users when evaluating potential modifications to the control configuration. As variants with quality scores that do not satisfy at least the threshold amount of criteria are unlikely to result in data with which users are likely to interact, leveraging historical interactions to determine quality scores for variants allows the online system to remove certain variants from evaluation without using currently-received interactions from users. Pruning variants based on their quality scores conserves computational resources expended and an amount of time spent generating data based on different variants for currently-received interactions from users.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates a flowchart of a method for determining whether to generate data using a variant of a control configuration of an online system, in accordance with one or more embodiments.

FIG. 4 illustrates a process flow of a method for determining whether to generate data using a variant of a control configuration of an online system, in accordance with one or more embodiments.

### DETAILED DESCRIPTION

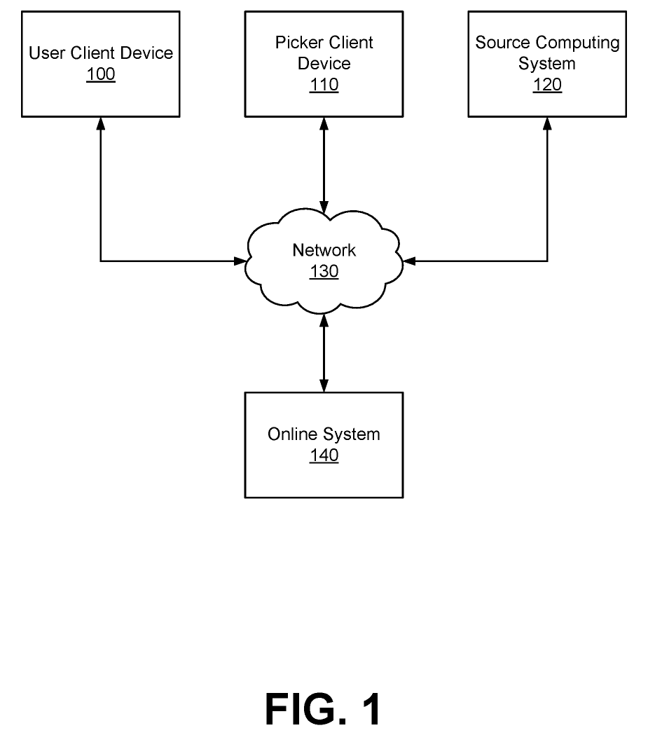

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user’s order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user’s order to the picker in a collection interface. The collection interface is a user interface that provides information to the picker on which items to collect for a user’s order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user’s order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker’s location. For example, if the picker takes a wrong turn while traveling to a delivery location, the online system 140 determines the picker’s updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. Patent Application No. 18/630,672, entitled “Automated Identification of Items Placed in a Cart and Recommendations based on Same,” filed April 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user’s order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user’s order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

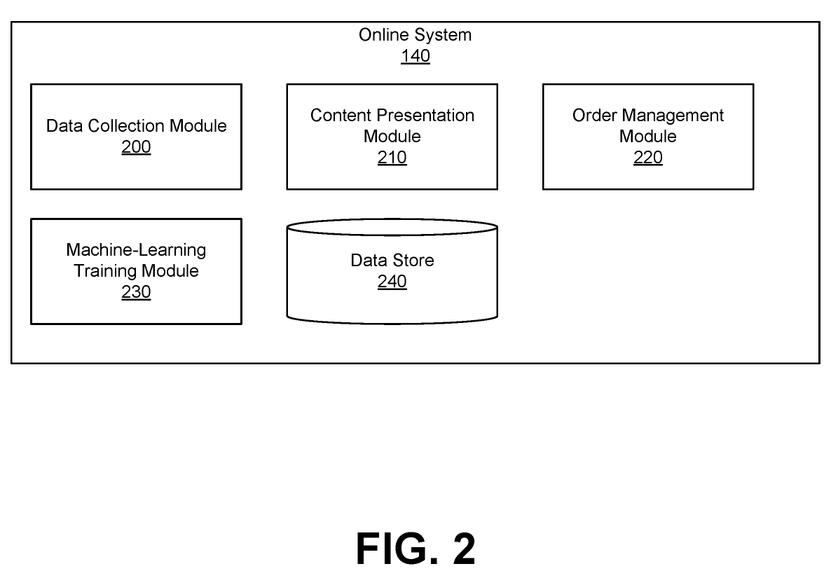

As an example, the online system 140 may allow a user to order groceries from a grocery store source. The user’s order may specify which groceries they want to be delivered from the grocery store and the quantities of each of the groceries. The user’s client device 100 transmits the user’s order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user’s name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user’s interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker’s name, the picker’s location, how often the picker has serviced orders for the online system 140, a user rating for the picker, which sources the picker has collected items at, or the picker’s previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker’s interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker’s performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The content presentation module 210 maintains a control configuration comprising instructions that, when executed by the content presentation module 210, generate data in response to one or more interactions received from users. For example, the control configuration includes instructions for selecting items in response to a received interaction from a user or instructions for ranking items that are selected in response to a received interaction. As another example, the control configuration includes instructions for positioning different items retrieved by the content presentation module 210 in an interface. The content presentation module 210 modifies the control configuration over time, which changes generation of data by the content presentation module 210 for users.

Because modifying the control configuration modifies content that is generated for users, the modifications affect subsequent interaction with the online system 140. For example, changes in how one or more items are presented in generated data may decrease subsequent user interaction with the online system 140 by increasing an amount of time for a user to identify items within the generated data. Conversely, other changes in how one or more items are presented in generated data may increase subsequent user interaction with the online system 140 by simplifying identification of items within the generated data. To account for the effects of changes in the control configuration on user interaction, the content presentation module 210 evaluates modifications to the control configuration before modifying the control configuration. As used herein, a “variant” refers to an alternative configuration for generating data relative to the control configuration currently used by the content presentation module 210. Hence, a variant is an alternative configuration for generating data having one or more variations from the control configuration. The content presentation module 210 evaluates one or more variants prior to replacing the control configuration with a variant to prevent replacing the control configuration with a variant that decreases subsequent user interaction with the online system 140.

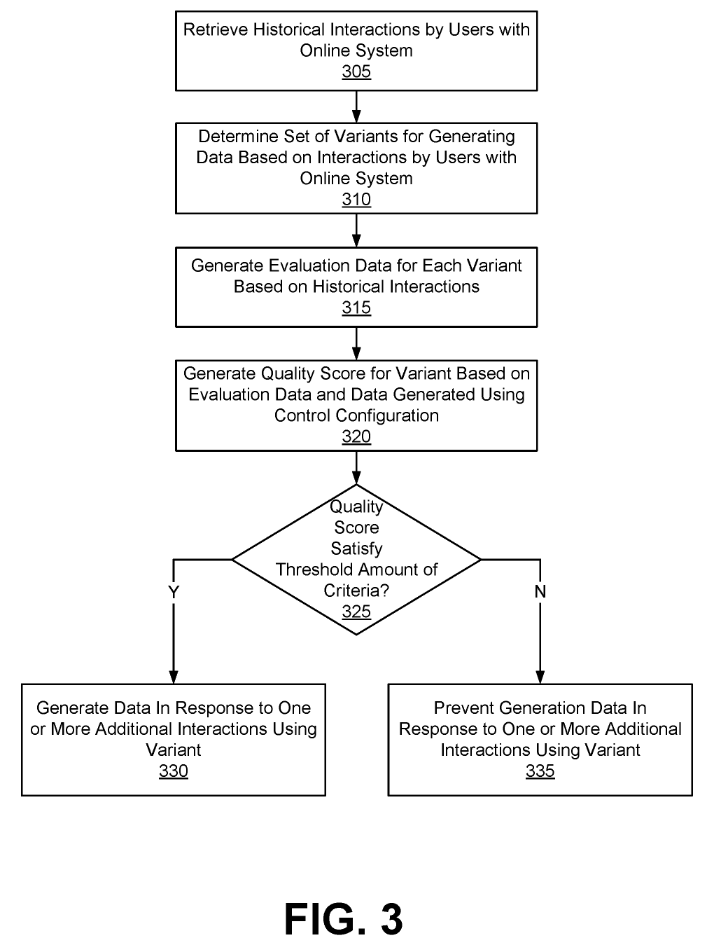

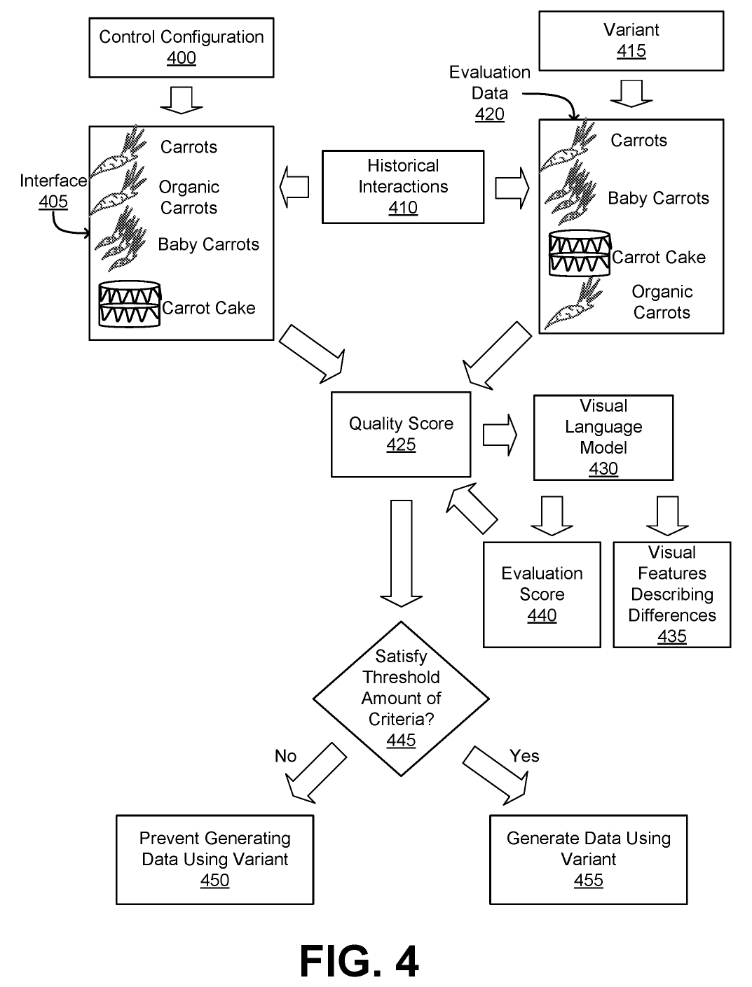

As further described below in conjunction with FIGS. 3 and 4, the content presentation module 210 retrieves historical interactions by users with the online system 140 from the data store to evaluate a variant. In various embodiments, the content presentation module 210 retrieves historical interactions and contextual information for each retrieved historical interaction. The content presentation module 210 uses the contextual information for a historical interaction to generate evaluation data for the historical interaction using the variant. For example, the content presentation module 210 retrieves a set of data based on the contextual information for the historical interaction and generates data, such as an interface, based on the variant and the retrieved set of data. Hence, the evaluation data represents data generated in response to a historical interaction using the variant rather than the control configuration.

The content presentation module 210 generates a quality score for the variant based on evaluation data generated using the variant for one or more historical interactions. As further described below in conjunction with FIGS. 3 and 4, a quality score for the variant is based on one or more metrics generated for the evaluation data for a historical interaction using the variant. The quality score for the variant may be determined based on interaction-specific quality scores generated based on different historical interactions. In some embodiments, the content presentation module 210 applies a visual language model (VLM) to the evaluation data for a historical interaction using the variant and to data generated for the historical interaction using the control configuration, with the VLM generating visual features comprising text describing differences between the evaluation data and the data generated using the control configuration. In some embodiments, the VLM additionally or alternatively generates an evaluation score for the variant indicating a relevance of the evaluation data to users relative to the data generated using the control configuration. The visual features or the evaluation score may be included in the quality score, along with the one or more metrics, in various embodiments.

The content presentation module 210 determines whether the quality score for the variant satisfies at least a threshold amount of criteria, as further described below in conjunction with FIGS. 3 and 4. In response to the quality score satisfying at least the threshold amount of criteria, the content presentation module 210 generates data using the variant in response to additional interactions received from at least a subset of users. However, in response to the quality score not satisfying at least the threshold amount of criteria, the content presentation module 210 prevents generation of data using the variant in response to additional interactions received from users. This prevents the content presentation module 210 from further evaluating a variant with a quality score that does not satisfy at least the threshold amount of criteria using additional received interactions from users. Filtering variants based on their quality score reduces a number of variants the content presentation module 210 uses to generate data in addition to the control configuration for evaluation, reducing an amount of computational resources the online uses 140 to generate data when evaluating variants for replacing the control configuration.

The order management module 220 manages orders for items from users. The order management module 220 receives orders from a user client device 100 and offers the orders to pickers for service based on picker data. For example, the order management module 220 offers an order to a picker based on the picker’s location and the location of the source from which the ordered items are to be collected. The order management module 220 may also offer an order to a picker based on how many items are in the order, a vehicle operated by the picker, the delivery location, the picker’s preferences on how far to travel to deliver an order, the picker’s ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker’s current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user’s order.

In some embodiments, the order management module 220 tracks the location of the picker within the source location. The order management module 220 uses sensor data from the picker client device 110 or from sensors in the source location to determine the location of the picker in the source location. The order management module 220 may transmit to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In various embodiments, the machine-learning training module 230 trains an assessment model to generate a probability of the online system 140 generating data using a variant based on a quality score of the variant. The machine-learning training module 230 applies the assessment model to multiple training examples of the training dataset. When applied to a training example, the assessment model generates a predicted probability of the online system 140 generating data using a training variant included in the training example based on a training quality score for the training example. The machine-learning training module 230 determines a score for the assessment model based on a difference between a label applied to a training example and a predicted probability for the training example (e.g., through application of a loss function to the label applied to the training example and the predicted probability for the training example). A label applied to the training example indicates whether the online system 140 generated data using the training variant included in the training example. For example, the label has a specific value in response to the online system 140 generating data using the training variant in the training example and has an alternative value in response to the online system 140 not generating data using the training variant in the training example. The machine-learning training module 230 updates the set of parameters for the assessment model based on the score generated by the loss function until one or more criteria are satisfied, as further described below in conjunction with FIG. 3.

In various embodiments, the machine learning training module 230 obtains a visual language model comprising a multimodal generative model that receives an image and text data as input. The visual language model generates an output based on the received image and text data. For example, the visual language model generates text data based on the received image and text data. As another example, the visual language model generates an output image based on the received image and text data. The visual language model is pre-trained on a set of multimodal training data, with the multimodal training data comprising an image and text corresponding to the image. Text corresponding to an image in the multimodal training data may be captions describing the image, labels of objects included in the image, or other descriptive information about the image. In some embodiments, the visual language model is pre-trained to perform one or more specific tasks, such as visual question answering, where the visual language model receives an image and a question about the image and generates an answer to the question based on the image. Pre-training of the visual language model for visual question answering may be performed by applying the visual language model to training examples each including a question and an image, with each training example labeled with an answer corresponding to the question included in the training example.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

In various embodiments, the data store 240 stores historical interactions the online system 140 received from users. For example, the data store 240 stores an identifier of a user who performed an interaction, a type of the interaction, and contextual information associated with the interaction. Examples of contextual information include: a time when the interaction was received, a location associated with the interaction (e.g., a location of a user from whom the interaction was received, a location of a source associated with the interaction), a source associated with the interaction, or other information describing the historical interaction. Storing historical interactions allows the data store 240 to maintain a record of interactions by users with the online system 140 over time.

FIG. 3 is a flowchart of a method for determining whether to generate data using a variant of a control configuration of an online system, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

An online system 140 generates data for presentation to users in response to one or more interactions based on a configuration. In various embodiments, the configuration comprises instructions that, when executed by the online system 140, generate data for presentation to users. For example, the configuration determines an order in which the online system 140 ranks items for presentation to a user in response to a search query or to another request for content. As another example, the configuration specifies a format or an order in which the online system 140 displays content to a user, such as one or more display characteristics of different items in an interface or relative positioning of items in an interface generated by the online system 140. Hence, the configuration comprises instructions that the online system 140 executes to generate data for presentation to a user in response to an interaction from the user.

Varying the configuration alters generation or presentation of data to users by the online system 140. Such alterations affect subsequent interactions with the online system 140 by users. As used herein, a “variant” refers to an alternative configuration of the online system 140 relative to a “control” configuration currently used by the online system 140. Hence, a variant is an alternative configuration for generating data having one or more variations from the control configuration. In various embodiments, different variants include different variations from the control configuration. Because variants alter data generated by the online system 140 for users, modifying the control configuration to a variant affects user interaction with the online system 140. So, the online system 140 evaluates how a subset of users interact with data generated using a variant and compares the user interaction with the data generated using the variant and interactions by other users with data generated using the control configuration when determining whether to subsequently use a variant in place of the control configuration for generating data.

In various embodiments, the online system 140 generates data based on a variant and presents the data generated based on the variant to a subset of users included in a test group. Subsequently, the online system 140 compares interactions by users in the test group with data generated based on the variant to interactions by users outside of the test group with data generated based on the control configuration. Based on the comparison, the online system 140 determines whether to subsequently generate content using the variant in place of the control configuration.

The online system 140 may use different variants to generate content for different test groups of users to evaluate multiple variants in parallel with each other. However, maintaining different variants and generating data using different variants is computationally expensive for the online system 140, as the online system 140 generates a larger amount of data for subsequent presentation to different users based on different variants. Additionally, maintaining multiple variants for generating data increases an amount of storage resources the online system 140 used to maintain different variants and criteria for determining different test groups of users Additionally, presenting data generated based on different variants and comparing user interactions with data generated based on the different variants to data generated based on the control configuration is time intensive, increasing an amount of time until the online system 140 uses a variant rather than the control configuration to generate data across users.

To more efficiently allocate computational resources for evaluating one or more variants, the online system 140 retrieves 305 historical interactions by users with the online system 140. In various embodiments, the online system 140 samples stored historical interactions to retrieve 305 having a range of attributes. For example, the online system 140 retrieves 305 historical interactions including different types of historical interactions, historical interactions associated with different locations, or historical interactions having different attributes.

The online system 140 previously generated data in response to the historical interactions using the control configuration. In various embodiments, the online system 140 retrieves 305 a historical interaction with the online system 140 by a user and obtains data the online system 140 generated in response to the historical interaction. For example, the online system 140 retrieves 305 a historical interaction stored in association with a user and generates data in response to the historical interaction using the control configuration. Alternatively, the online system 140 stores data generated based on the control configuration in association with an interaction, so the online system 140 retrieves 305 a historical interaction and the data generated in response to the historical interaction using the control configuration.

Additionally, the online system 140 retrieves contextual information stored in association with each historical interaction. An example of contextual information associated with a historical interaction comprises a type of the interaction, such as an indication that the historical interaction is a search query or an indication that the historical interaction is a request to browse items available from a source (or from the online system 140). Another example of contextual information associated with a historical interaction comprises a location associated with a user who performed the historical interaction. In some embodiments the location comprises an identifier of a geographic region including a location associated with the user, while in other embodiments the online system 140 stores the location associated with the user. As another example, contextual information associated with a historical interaction comprises an identifier of a source associated with the historical interaction; for example, the online system 140 stores and retrieves 305 an identifier of a source from which content was retrieved in response to a historical interaction or retrieves an identifier of a source identified by an interaction. Retrieving the contextual information associated with a historical interaction allows the online system 140 to regenerate data in response to the historical interaction using the contextual information associated with the historical interaction.

For example, one or more historical interactions comprise search queries and data generated by the online system 140 in response to a historical search query comprises an interface displaying search results based on the control configuration. The online system 140 retrieves 305 a historical search query as well as contextual information associated with the historical search query (e.g., a source associated with the historical search query, a location associated with the historical search query, etc.) and applies the historical search query to the associated contextual information to retrieve items satisfying the search query and to generate an interface displaying the retrieved items based on the control configuration. In various embodiments, the online system 140 obtains metadata for different portions of data generated in response to a historical interaction using the control configuration. For example, the online system 140 retrieves items in response to a historical interaction, so the online system 140 obtains attributes of each item retrieved in response to the historical interaction. In some instances, attributes of an item may contain contextual information associated with the historical interaction. Example attributes of an item include: a position in an interface where an item was presented, one or more keywords associated with the item, an item category associated with the item, a measure of relevance of an item to the historical interaction (e.g., a dot product of an embedding of the item to an embedding of the historical interaction), an identifier of the item, or other attributes comprising descriptive information about the item.

The online system 140 determines 310 a set of variants for generating data in response to interactions. Each variant has one or more differences relative to the control configuration. For example, a variant modifies how the online system 140 ranks search results in response to a search query. As another example, a variant modifies how the online system 140 displays data relative to each other in an interface in response to an interaction; as an example, the variant alters positioning of search results relative to each other in an interface generated in response to a search query. In another example, a variant modifies visual features of one or more items (or other data) in an interface generated in response to an interaction. In some embodiments, the online system 140 determines 310 a single variant to be evaluated, while in other embodiments the online system 140 determines 310 multiple variants to be evaluated. One or more variants may be determined 310 from one or more inputs received from an administrative user. As another example, the online system 140 automatically determines 310 one or more variants.

Rather than evaluate a variant by using the variant to generate data in response to subsequently received interactions from a subset of users of the online system 140, the online system 140 generates 315 evaluation data for the variant using historical interactions and their associated contextual information. The online system 140 generates 315 evaluation data by using the variant to generate data in response to a historical interaction based on the contextual information associated with the historical interaction. For example, the evaluation data is an interface including items selected for or presented for a historical interaction using the variant. In various embodiments, the online system 140 retrieves a set of data based on contextual information associated with a historical interaction and executes instructions comprising the variant based on the historical interaction and the retrieved set of data, so the variant is applied to data determined based on the contextual information associated with the historical interaction. Hence, the evaluation data illustrates generation of data in response to the historical interaction using the variant. The online system 140 stores the evaluation data in association with the variant and with the historical interaction used to generate the evaluation data. As further described above, the variant modifies positioning of data relative to each other in an interface compared to a corresponding interface generated using the control configuration, modifies ranking of different data relative to each other when generating an interface relative to using the control configuration, modifies visual features of one or more portions of data in an interface relative to generating the interface using the control configuration, or otherwise modifies selection or presentation of data relative to the control configuration.

In various embodiments, evaluation data for a variant comprises an interface generated by the online system 140 for a historical interaction using contextual information associated with the historical interaction based on the variant. The contextual information allows the online system 140 to replicate conditions when the online system previously generated data for the historical interaction using the control configuration when generating 315 evaluation data for the variant. Generating an interface as evaluation data for a historical interaction based on the variant allows the evaluation data to indicate how the variant generates or presents data. Using historical interactions, with their associated contextual information, allows generation 315 of evaluation data for a variant without generating data to evaluate the variant in response to currently received interactions from users. Leveraging historical interactions by users to generate 315 evaluation data for the variant decreases an amount of time for generating 315 evaluation data for the variant relative to configurations where the online system 140 generates evaluation data based on subsequently received interactions from a specific test subset of users based on the variant.

For each variant, the online system 140 generates 320 a quality score measuring data generated using the variant. In various embodiments, the online system 140 generates 320 different quality scores for the variant corresponding to different evaluation data generated 315 from different historical interactions. For a particular historical interaction, the quality score for the variant measures relevance or other attributes of the evaluation data generated 315 for the particular historical interaction using the variant. In various embodiments, the online system 140 generates 320 the quality score for the variant by combining quality scores generated for different historical interactions. For example, the online system 140 determines a mean, a median, or a mode of the quality scores generated for different historical interactions as the quality score for the variant.

In some embodiments, the quality score comprises a difference between one or more values determined for evaluation data generated using the variant and one or more control values determined for data generated using the control configuration. For example, the online system 140 determines a value based on evaluation data generated using the variant and a historical interaction and determines a control value based on data generated using the control configuration and the historical interaction. The online system 140 generates 320 the quality score for the variant as a difference between the value and the control value, so the quality score describes one or more changes between the evaluation data and the data generated based on the control configuration. As further described above, the online system 140 uses the particular historical interaction and its associated contextual information to generate 315 the evaluation data based on the variant and to generate the data for the particular historical interaction based on the control configuration. For example, the online system 140 generates an interface displaying evaluation search results for a historical search query based on the variant and generates a control interface displaying search results for the historical search query using the control configuration. In the preceding example, a quality score generated 320 for the variant provides a measure of changes between the interface displaying the evaluation search results and the control interface.

When generating 320 the quality score for the variant, the online system 140 generates one or more metrics for the evaluation data generated 315 based on the variant. In some embodiments, the quality score comprises a set of metrics generated for the evaluation data. For example, a metric comprises a measure of precision of items retrieved by the online system 140 for items retrieved for a particular historical interaction based on the variant. A measure of precision for a particular historical interaction is based on a ratio of a number of items relevant to the particular historical interaction retrieved by the online system to a total number of items retrieved by the online system for the particular historical interaction. In some embodiments, an additional or alternative metric comprises a normalized discounted cumulative gain of a ranking of items retrieved for a particular historical interaction based on the variant. However, in other embodiments, the online system 140 generates one or more metrics.

In various embodiments, the online system 140 generates one or more metrics for evaluation data generated for a historical interaction based on the variant and generates one or more control metrics for data generated for the historical interaction based on the control configuration. The online system 140 stores the control metrics as threshold values for evaluating the variant in some embodiments. Alternatively, the online system 140 determines a difference between a metric for the evaluation data and a corresponding control metric for the data generated for the historical interaction based on the control configuration. The online system 140 stores the differences between metrics for the evaluation data and corresponding control metrics for the data generated for the historical interaction based on the control configuration as the quality score for the variant in some embodiments. In other embodiments, the online system 140 generates 320 the quality score based on the differences (e.g., an average difference, a median difference, a mode difference, etc.).

In various embodiments, the online system 140 applies a visual language model (VLM) to the evaluation data for the variant for the particular historical interaction and to the data generated for the particular historical interaction when generating 320 the quality score for the variant. The VLM generates text describing one or more visual features describing differences between evaluation data and data generated using the control configuration. The VLM comprises a multimodal generative model that receives one or more images and text data as input. The VLM generates an output based on the received images and text data. For example, the VLM generates text data based on the received images and text data. In various embodiments, the VLM generates text data describing differences between different images received as input.

The VLM is pre-trained on a set of multimodal training data, with the multimodal training data comprising various combinations of images and text corresponding to each image. Different images and corresponding text are included in the multimodal training data, so the VLM learns relationships between different content of images and different text. In some embodiments, the VLM is pre-trained to perform one or more specific tasks, such as visual question answering, where the VLM receives one or more images and a question about the one or more images as input and generates an answer to the question based on the image. For example, the online system 140 applies a VLM to a pair of images and to a prompt requesting the VLM identify one or more differences between the pair of images. In various embodiments, the online system 140 applies the VLM to various combinations of the evaluation data, data generated based on the control configuration, and different prompts to generate text describing various differences between the evaluation data and the data generated based on the control configuration. Further, in various embodiments, the online system 140 applies multiple VLMs to the evaluation data and to the data generated based on the control configuration to generate text describing different variations between the evaluation data and the data generated based on the control configuration.

In various embodiments, the VLM generates text describing one or more differences between the evaluation data for the variant for a particular historical interaction and the data generated for the particular historical interaction using the control configuration. For example, text generated by the VLM describes differences in positioning of one or more items in an interface comprising the evaluation data and in a control interface comprising the data generated using the control configuration. As another example, the VLM generates text describing differences in display of one or more items in an interface comprising the evaluation data and in a control interface generated using the control configuration. In the preceding examples, the VLM generates text identifying one or more items in the evaluation data and a change in a location of corresponding items in the evaluation data relative to the control interface or generates text describing differences in visual presentation of one or more items in the evaluation data relative to visual presentation of the one or more items in the control interface.

Additionally or alternatively, the VLM generates an evaluation score based on changes between the evaluation data for the particular historical interaction using the variant and the data generated for the particular historical interaction using the control configuration in some embodiments. In various embodiments, the evaluation score comprises an indication whether the evaluation data is more relevant to a user than the data generated using the control configuration. For example, the evaluation score has a first value in response to the VLM determining the evaluation data is more relevant to the user than the data generated using the control configuration and has a second value in response to the VLM determining the evaluation data is less relevant to the user than the data generated using the control configuration. The evaluation score may have an alternative value in response to the VLM determining the evaluation data and the data generated using the control configuration are equally relevant to users. The VLM bases the evaluation score on differences between the evaluation data for the variant for the particular historical interaction and the data generated for the particular historical interaction based on the control configuration, as well as contextual information associated with the particular historical interaction, to determine information about changes in relevance to a user of the evaluation data relative to the data generated based on the control configuration. The evaluation score accounts for contextual information associated with the particular historical interaction, allowing the VLM to account for variations between different historical interactions when generating the evaluation score.

In some embodiments, the quality score includes the evaluation score from the VLM and one or more metrics. For example, the quality score is a set of values including the one or more metrics and the evaluation score. Alternatively, the online system 140 combines the evaluation score and the one or more metrics into a single evaluation score. In some embodiments, the quality score includes the one or more metrics and one or more visual features generated from the VLM. The online system 140 combines or aggregates quality scores generated for different particular historical interactions for the variant to generate 320 the quality score for the variant. In various embodiments, the online system 140 performs one or more statistical methods to determine a quality score for the variant based on quality scores for the variant for different historical interactions. The online system 140 determines a quality score for each variant of the set in various embodiments, while in other embodiments the online system 140 determines a quality score for each of a subset of the variants.

The online system 140 determines 325 whether a quality score of a variant satisfies a threshold amount of criteria. In various embodiments, the online system 140 maintains one or more rules for determining 325 whether the quality score of the variant satisfies the threshold amount of criteria. In embodiments where the quality score includes one or more metrics, different rules specify different threshold values corresponding to various metrics. Further, in embodiments where the quality score includes an evaluation score generated by the VLM, one or more rules specify a threshold score for the evaluation score.

In response to determining 325 the quality score of the variant satisfies the threshold amount of criteria, the online system 140 subsequently generates 330 data in response to one or more additional interactions received from users using the variant. For example, the online system 140 generates 330 data using the variant in response to additional interactions received from a subset of users, obtaining additional information about user interaction with data generated 330 using the variant. Generating data using the variant in response to the quality score of the variant satisfying the one or more criteria obtains additional information about user interaction with data generated by the variant to further evaluate user interaction with data generated by the variant relative to data generated by the control configuration.

However, in response to determining 325 the quality score of the variant does not satisfy the one or more criteria, the online system 140 prevents 335 subsequent generation of data in response to additional user interactions using the variant. In some embodiments, the online system 140 deletes the variant to prevent 335 subsequent generation of data using the variant. Alternatively, the online system 140 stores an indication in association with the variant to prevent 335 subsequent use of the variant for generating content in response to additional user interactions. Preventing use of the variant with a quality score that does not satisfy at least the threshold amount of criteria reduces a number of variants maintained and used to generate data for additional interactions. Such reduction in the number of variants generating data in response to additional interactions reduces computing resources used by the online system 140 by liming a number of variants used to generate data in response to additional interactions.

In various embodiments, the online system 140 determines 325 the quality score of the variant does not satisfy the threshold amount of criteria in response to one or more metrics comprising the quality score being less than corresponding threshold values. For example, the online system 140 prevents 335 use of the variant for generating content in response to a metric indicating precision of the variant is less than a threshold precision. As another example, the online system 140 prevents 335 use of the variant for generating content in response to a metric indicating normalized discounted cumulative gain of the variant is less than a threshold value. In various embodiments, the online system 140 prevents 335 generation of data using the variant in response to at least a threshold number of metrics being less than their corresponding threshold values. For example, the online system 140 prevents 335 use of the variant for generating content in response to one or more metrics included in the quality score being less than their corresponding threshold value and in response to an evaluation score included in the quality score being less than a threshold evaluation score.

Alternatively, the online system 140 applies a trained assessment model to variant and the quality score for the variant to generate a probability for the variant. In various embodiments, the assessment model receives an identifier of a variant and a quality score for the variant as input. Alternatively, the assessment model receives the variant and the quality score for the variant as input. The assessment model comprises a set of weights stored on a non-transitory computer readable storage medium in various embodiments. The online system 140 trains the assessment model by generating a training dataset including multiple training examples. Each training example includes a training variant and a training quality score of the training variant. Each training example also has a label indicating whether the training variant was used to generate data in response to interactions from users. For example, the label has a specific value in response to the online system 140 using the training variant to generate data in response to interactions from users and has an alternative value in response to the training variant not being used to generate data in response to interactions from users. In various embodiments, the training variants are variants that were previously evaluated by the online system 140, as further described above.

To train the assessment model, the online system 140 initializes the set of weights comprising the assessment model and applies the assessment model to multiple training examples of the training dataset. Applying the assessment model to multiple training examples updates the parameters (e.g., the weights) comprising the assessment model. The parameters comprising the assessment model transform the input data – a variant and a quality score for the variant –– into a probability of the online system 140 using the variant to generate data. When applied to a training example, the assessment model generates a predicted probability of the online system 140 using the training variant to generate data in response to interactions from users based on the quality score of the training variant.

For each training example to which the assessment model is applied, the online system 140 generates a score comprising an error term based on the predicted probability of the online system 140 using the training variant to generate data in response to interactions from users and the label applied to the training example. The error term is larger when a difference between the predicted probability of the online system 140 using the training variant to generate data in response to interactions from users and the label applied to the training example is larger and is smaller when the difference between the predicted probability of the online system 140 using the training variant to generate data in response to interactions from users and the label applied to the training example is smaller. In various embodiments, the online system 140 generates the error term using a loss function based on a difference between the predicted probability of the online system 140 using the training variant to generate data in response to interactions from users and the label applied to the training example using a loss function. Example loss functions include a mean square error function, a mean absolute error, a hinge loss function, and a cross-entropy loss function.

The online system 140 backpropagates the error term to update the set of parameters comprising the assessment model and stops backpropagation in response to the error term, or to the loss function, satisfying one or more criteria. For example, the online system 140 backpropagates the error term through the assessment model to update parameters of the assessment model until the error term has less than a threshold value. For example, the online system 140 may apply gradient descent to update the set of parameters. The online system 140 stores the set of parameters comprising the assessment model on a non-transitory computer readable storage medium after stopping the backpropagation.

In various embodiments, the online system 140 prevents 335 using the variant for generating content in response to the probability of the online system 140 using the variant to generate data in response to interactions received from users being less than a threshold probability. However, the online system 140 generates 330 data in response to one or more additional interactions received from users based on the variant in response to the probability of the online system 140 using the variant to generate data in response to interactions received from users equaling or exceeding the threshold probability.

Limiting generation of data to variants having quality scores satisfying at least a threshold amount of criteria conserves computational resources used by the online system 140 to evaluate potential modifications to the control configuration. By using historical interactions and associated contextual information to generate evaluation data for variants, the online system 140 filters variants less likely to generate data relevant to users from generating data in response to newly received interactions from users. Generating evaluation data from historical interactions also reduces an amount of user interaction the online system 140 obtains when evaluating variant, conserving storage resources used by the online system 140 when evaluating one or more variants for replacing the control configuration.

FIG. 4 is a process flow diagram of one or more embodiments of a method for determining whether to generate data using a variant of a control configuration of an online system 140. An online system 140 uses a control configuration 400 to generate data for presentation to one or more users in response to interactions received from users. The control configuration 400 comprises instructions that, when executed by the online system 140, select data and format data for presentation to a user. For example, the control configuration 400 specifies how the online system 140 ranks or selects data for presentation to a user in response to an interaction from the user. As another example, the control configuration 400 specifies how the online system 140 displays different data to a user in response to an interaction from the user. Hence, the control configuration 400 comprises instructions specifying how the online system 140 generates data in response to receiving an interaction from the user. For example, the control configuration 400 specifies how the online system 140 generates an interface presenting search results based on a search query; for example, the control configuration 400 specifies how the online system 140 ranks search results or how the online system 140 displays search results relative to each other in an interface.

Data generated based on the control configuration 400 affects subsequent user interaction with the online system 140. For example, relevance of items the control configuration 400 selects as search results for a received a search query from a user increases or decreases an amount of subsequent interaction by the user with the online system 140. If the control configuration 400 generates search results having a larger number of items that are relevant to a search query and more visible in an interface to a user, the user is more likely to select one or more of the items or to subsequently provide additional search queries to the online system 140. Conversely, if the control configuration 400 generates search results having a smaller number of items that are relevant to a search query from a user or presents items having higher relevance to the search query in less visible positions in an interface, the user is less likely to select one or more of the items or to subsequently provide additional search queries to the online system 140.

In the example shown by FIG. 4, the online system 140 generates interface 405 based on the control configuration 400 in response to an interaction from a user. For example, interface 405 includes search results selected and presented based on the control configuration 400. The control configuration 400 determines which items the online system 140 selects for presentation via interface 405, and determines an order in which interface 405 presents the items in various embodiments. In other embodiments, the control configuration 400 specifies different attributes of interface 405.

The online system 140 stores interactions received from users, maintaining a record of historical interactions 410 by users with the online system 140. In various embodiments, the online system 140 stores an identifier of a user and a type of interaction for a historical interaction 410. As further described above in conjunction with FIG. 3, the online system 140 stores contextual information in association with an interaction. Example contextual information includes a time when the online system 140 received an interaction, a location associated with a user from whom the interaction was received, an identifier of a source (e.g., a source of items, a source of content) associated with the interaction. Additional or alternative contextual information may be stored in association with interactions in various embodiments. For example, the online system 140 stores historical interactions 410 received from users and contextual information associated with each historical interaction in the data store 240 further described above in conjunction with FIG. 2. In some embodiments, the online system 140 also stores data generated in response to a historical interaction in association with the historical interaction. For example, the online system 140 stores an interface generated in response to an interaction in association with the interaction.

Data generated based on the control configuration 400 affects subsequent user interaction with the online system 140, so modifying the control configuration 400 influences how users interact with the online system 140 over time. For example, modifying how an interface presents data based on the control configuration 400 may increase a frequency with which a user interacts with the online system 140 or may increase a frequency with which the user selects data included in the generated interface. However, modifications to the control configuration 400 may decrease subsequent user interaction with the online system 140, so the online system 140 evaluates how modifications to the control configuration 400 affect user interactions prior to using such modifications to generate data for users.

An alternative configuration for the online system 140 to generate content is referred to herein as a “variant.” Modifications to the control configuration evaluated for subsequent content generation are variants of the control configuration. A variant includes one or more differences from the control configuration 400. For example, a variant modifies an order in which items are ranked by the online system 140 or modifies how one or more items are displayed in an interface by the online system 140 relative to the control configuration 400. However, in other embodiments, a variant has different or additional differences from the control configuration 400.

The online system 140 determines one or more variants from the control configuration 400 for evaluation. For purposes of illustration, FIG. 4 shows an example where the online system 140 determines variant 415 from the control configuration 400. In the example of FIG. 4, variant 415 modifies ranking of items retrieved in response to an interaction relative to the control configuration 400. However, in other embodiments, variant 415 has different or additional variations relative to the control configuration 400.

To evaluate whether to generate data using variant 415 rather than the control configuration 400, the online system 140 retrieves a set of historical interactions 410. In various embodiments, the online system 140 also retrieves contextual information associated with the historical interactions 410. Retrieving contextual information associated with a historical interaction 410 allows the online system 140 to obtain additional descriptive information about when a historical interaction was received and descriptive information about one or more sources used to generate data in response to the historical interaction.

Based on a historical interaction 410, the online system 140 generates evaluation data 420 for variant 415. The evaluation data 420 comprises data generated by the online system 140 using variant 415 in response to the historical interaction. Hence, the evaluation data 420 indicates how the online system 140 would have generated data in response to the historical interaction 410 using variant 415. In various embodiments, the online system 140 retrieves a set of data corresponding to the contextual information associated with a historical interaction 410 and generates data based on the retrieved set of data and the historical interaction 410 using variant 415. For example, the online system 140 selects a subset of items from the retrieved data based on the historical interaction 410 and generates a ranking of the subset of items based on variant 415. An interface displaying the subset of items in the ranking based on variant 415 comprises the evaluation data 420 for variant 415 in various embodiments. In the example of FIG. 4, the evaluation data 420 for variant 415 is an interface having identifiers for items “baby carrots,” “carrot cake,” and “organic carrots” in different positions of a ranking relative to the positions of items “baby carrots,” “carrot cake,” and “organic carrots” in a ranking based on the control configuration 400.

Additionally, the online system 140 obtains the interface 405 in response to the historical interaction 410 using the control configuration 400. In some embodiments, the online system 140 retrieves the contextual information associated with the historical interaction 410, retrieves a set of data based on the contextual information, and generates the interface 405 from the set of data using the historical interaction 410 and the control configuration 400. As another example, the online system 140 retrieves the interface 405, which was stored in association with the historical interaction 410 when the historical interaction 410 was initially received by the online system 140. Obtaining the interface 405 allows comparison of the interface 405 generated for the historical interaction 410 based on the control configuration 400 to the evaluation data 420 generated for the historical interaction 410 based on variant 415.

Based on changes between the interface 405 and the evaluation data 420 for the historical interaction 410, the online system 140 generates a quality score 425 for variant 415. In various embodiments, the online system 140 generates one or more metrics based on the evaluation data 420 for variant 415 as the quality score 425. As another example, the online system 140 generates the quality score 425 based on differences between metrics based on the evaluation data 420 and metrics based on the interface 405 generated based on the control configuration 400. For example, the one or more metrics provide measures of effects of differences between the evaluation data 420 and the interface 405 on user interaction, or likelihood of user interaction, with the evaluation data 420. For example, a metric comprises a measure of precision of items retrieved by the online system 140 for the historical interaction 410 based on variant 415, as further described above in conjunction with FIG. 2. An additional or alternative metric comprises a normalized discounted cumulative gain of a ranking of items in evaluation data 420 based on variant 415, as further described above ion conjunction with FIG. 2. However, in other embodiments, the online system 140 generates one or more additional or alternative metrics for variant 415 based on the evaluation data 420. In various embodiments, the online system 140 also determines the metrics for the interface 405 based on the generated in response to historical interaction 410, allowing comparison of the metrics for variant 415 to the metrics for the control configuration 400. For example, the one or more metrics for the interface 405 may be used as threshold values for the quality score 425. As another example, the online system 140 generates the quality score 425 based on differences between metrics for the evaluation data 420 and corresponding metrics for the interface 405. In some embodiments, the quality score 425 for variant 415 comprises a set of metrics generated based on the evaluation data 420 for variant 415. However, in other embodiments, the online system 140 combines one or more metrics generated based on the evaluation data 420 into a single quantity comprising the quality score for variant 415.

In various embodiments, the online system 140 also applies a visual language model (VLM) 430 to the interface 405 and to the evaluation data 420. As further described above in conjunction with FIG. 3, the VLM 430 receives the interface 405, the evaluation data 420, and a prompt to identify differences between the interface 405 and the evaluation data 420 as input. In response to the input, the VLM 430 generates text describing one or more visual features 435 that describe differences between data generated for a historical interaction 410 using the control configuration 400 and the evaluation data 420 generated for the historical interaction 410 using variant 415. For example, the visual features 435 comprise text describing differences between presentation of data in the interface 405 and in the evaluation data 420. For example, the visual features 435 generated by the VLM 430 identify differences in positions of items in the interface 405 and in the evaluation data 420. In the example of FIG. 4, the visual features 435 indicate that “organic carrots” moved down two positions in the evaluation data 420 relative to the interface 405, that “baby carrots” moved up one position in the evaluation data 420 relative to the interface 405, and that “carrot cake” moved up one position in the evaluation data 420 relative to the interface 405. Hence, the visual features 435 provide a summary of visual differences between the interface 405 and the evaluation data 420, simplifying identification of differences between data generated by the control configuration 400 and data generated by variant 415.

The VLM 430 also generates an evaluation score 440 for variant 415 based on changes between the evaluation data 420 and the interface 405 in various embodiments. For example, the evaluation score 440 comprises an indication whether the evaluation data 420 is more relevant to a user than the interface 405 generated using the control configuration 400. For example, the evaluation score 440 has a first value in response to the VLM 430 determining the evaluation data 420 is more relevant to the user than the interface 405 and has a second value in response to the VLM 430 determining the evaluation data 420 is less relevant to the user than the interface 405. The evaluation score 440 may have an alternative value in response to the VLM determining the evaluation data 420 and the interface 405 are equally relevant to users. The evaluation score 440 accounts for contextual information associated with the particular historical interaction 410, allowing the VLM 430 to account for variations between different historical interactions 410 (e.g., different users, different locations, different types of historical interactions, etc.) when generating the evaluation score 440.

In various embodiments, the quality score 425 includes one or more metrics generated as further described above and the evaluation score 440 generated by the VLM 430. Alternatively, the online system 140 combines the one or more metrics and the evaluation score 440 into a single quantity comprising the quality score 425. In some embodiments, the quality score 425 includes the one or more metrics and one or more visual features 435 generated from the VLM 430. Hence, the quality score 425 for variant 415 accounts for statistical evaluation of the evaluation data 420 from the one or more metrics, as well as the evaluation score 440 from the VLM 430 comparing the evaluation data 420 to the interface 405.

The online system 140 determines a quality score 425 for variant 415 for different historical interactions 410 and determines the quality score 425 for variant 415 based on the different interaction-specific quality scores 425 for different historical interactions 410 in various embodiments. For example, the online system 140 determines a quality score 425 for variant 415 for each of a set of historical interactions 410 and determines the quality score 425 for variant 415 as an average, or other statistical quantity, based on interaction-specific quality scores 425 for each of the historical interactions 410 of the set. Hence, the quality score 425 for the variant provides a measure of changes between the evaluation data 420 and the interface 405. In various embodiments, the quality score 425 is based on a difference between expected relevance of the evaluation data 420 and the interface 405 to users or based on a difference between expected interaction by users with data included in the evaluation data 420 and with data included in the interface 405.

Leveraging the stored historical interactions 410 to generate data for one or more historical interactions 410 using the control configuration 400 and to generate evaluation data 420 for one or more historical interactions 410 using variant 415 allows evaluation of differences in data generated using the control configuration 400 and using variant 415. Using historical interactions 410 previously received from users allows initial evaluation of variant 415 without expending computational resources of the online system 140 to generate data in response to recently received interactions from users based on variant 415. Using the control configuration 400 to generate data for newly received interactions from users, while generating a quality score 425 for variant 415 based on historical interactions 410 allows the online system 140 to evaluate variant without expending computational resource to generate data for newly received interactions using both the control configuration 400 and variant 415.

While the quality score 425 for variant 415 provides an initial measure of effectiveness of variant 415 before modifying the control configuration 400 to variant 415, the online system 140 obtains further information about user interaction with data generated by variant 415 based on additional interactions that are newly received from users. For example, the online system 140 generates data using variant 415 for interactions received from a subset of users, while generating data using the control configuration 400 for interactions received from other users. As differently generating data for different users increases computational resources expended to present content, the online system uses the quality score 425 for variant 415 to determine whether to use variant 415 to generate data for additionally received interactions.

To reduce computational resources used to evaluate variant 415 against the control configuration 400, the online system 140 determines 445 whether the quality score 425 for variant 415 satisfies at least a threshold amount of criteria. In response to determining 445 the quality score 425 does not satisfy at least the threshold amount of criteria, the online system prevents 450 generation of content using variant 415 in response to additional user interactions (e.g., during an experiment). In some embodiments, the online system 140 maintains a set of rules to which the quality score 425 is compared. For example, different rules specify different threshold values for one or more metrics comprising the quality score 425. In response to the online system 140 determining 445 the quality score 425 does not satisfy at least a threshold amount of rules (e.g., a threshold amount of metrics comprising the quality score 425 are less than corresponding threshold values specified by rules), the online system 140 prevents 450 user of variant 415 for generating data for additional interactions. In an example, a set of rules includes threshold values for each of one or more metrics and a threshold evaluation score for the evaluation score 440 generated by the VLM 430. In response to determining 445 the quality score 425 includes at least a threshold amount of metrics with values less than corresponding threshold values and includes an evaluation score 440 less than the threshold evaluation score, the online system 140 prevents 450 generation of data using variant 415. In other embodiments, the online system 140 prevents 450 generation of data using variant 415 in response to one or more specific metrics included in the quality score 425 being less than corresponding threshold values.

Alternatively, the online system 140 applies an assessment model to variant 415 and the quality score 425 for variant 415. As further described above in conjunction with FIG. 3, the assessment model generates a probability of generating data for variant 415 based on the quality score 425 for variant 415. The assessment model may be trained through a backpropagation process using training examples. Each training example includes a training variant and a corresponding training quality score; further, each training example has a label indicating whether a training variant was used to generate content in response to interactions from users. In response to the probability of generating data for variant 415 from the assessment model being less than a threshold probability, the online system 140 prevents 450 generation of data in response to additional interactions from users based on variant 415.

However, in response to determining 445 the quality score 425 for variant 415 satisfies at least the threshold amount of criteria, the online system 140 subsequently generates 455 data based on variant 415 in response to additional interactions from users (e.g., during an experiment). For example, the online system 140 generates 455 data based on variant 415 in response to the probability from the assessment model equaling or exceeding the threshold probability. In various embodiments, the online system 140 generates 445 data based on variant 415 in response to additional interactions received from a subset of users, while generating data based on the control configuration 400 in response to additional interactions from other users. This allows the online system 140 to further evaluate user responses to data generated based on variant 415 against user responses to data generated based on the control configuration 400.

Limiting generation of data for additional interactions from users to variants having quality scores satisfying at least the threshold amount of criteria limits a number of variants used to generate data. Reducing the number of variants for generating content conserves computing resources the online system 140 uses for data generation in response to interactions from users when evaluating potential modifications to the control configuration 400. As variants with quality scores that do not satisfy at least the threshold amount of criteria are unlikely to result in data with which users are likely to interact, leveraging historical interactions 410 to determine quality scores for variants allows the online system to remove certain variants from evaluation without using currently-received interactions from users. Filtering variants based on their quality scores conserves computational resources expended and an amount of time spent generating data based on different variants for currently-received interactions from users.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
retrieving historical interactions by users with the computer system, the computer system generating data in response to the historical interactions using a control configuration;
generating a set of variants, each variant having one or more differences from the control configuration;
generating evaluation data for each variant, wherein the evaluation data for each variant is generated by simulating the computer system to generate the evaluation data in response to the historical interactions using the variant;
generating a quality score for each variant, wherein the quality score for each variant measures a difference between the evaluation data generating using the variant and the data generated using the control configuration;
pruning one or more of the variants to select a subset of variants for testing, wherein the one or more variants are pruned by applying one or more criteria to the quality scores; and
executing a software process that performs an experiment on the selected subset of variants, wherein the experiment causes the computer system to generate data in response to additional interactions received from users based on the selected subset of variants and the control configuration, and evaluate the selected variants based on the interactions.

2. The method of claim 1, wherein generating the quality score for each variant comprises:
generating text describing one or more visual features for the variant by applying a visual language model to the evaluation data generating using the variant and the data generated using the control configuration;
generating one or more metrics based on differences between the evaluation data generating using the variant and the data generated using the control configuration; and
generating the quality score for the variant based on the one or more visual features and the one or more metrics.

3. The method of claim 2, wherein generating text describing one or more visual features for the variant by applying the visual language model to the evaluation data generating using the variant and the data generated using the control configuration comprises:
generating, by the visual language model, an evaluation score based on changes between the evaluation data generated using the variant and the data generated using the control configuration.

4. The method of claim 3, wherein pruning one or more of the variants to select the subset of variants for testing comprises:
for a particular variant, in response to the evaluation score being less than a threshold evaluation score and one or more of the metrics being less than a corresponding threshold value, pruning the particular variant.

5. The method of claim 2, wherein pruning one or more of the variants to select the subset of variants for testing comprises:
for a particular variant, in response to the one or more of the metrics being less than a threshold value, pruning the particular variant.

6. The method of claim 1, wherein pruning one or more of the variants to select the subset of variants for testing comprises, for each variant:
generating a score for the variant based on the quality score for the variant by applying an assessment model to the quality score for the variant, wherein the assessment model is a machine learning model trained by:
obtaining a training dataset including a plurality of training examples, each training example including a training variant and a training quality score, each training example having a label indicating whether the training variant was used to generate data in response to interactions from users;
applying the assessment model to each training example of the training dataset to generate a predicted probability of using the training variant to generate data in response to interactions from users;
scoring the assessment model using a loss function applied to the predicted probability of using the training variant to generate data in response to interactions from users and the label of the training example; and
updating one or more parameters of the assessment model by backpropagation based on the scoring until one or more criteria are satisfied; and
in response to the predicted probability being less than a threshold probability, pruning the variant.

7. The method of claim 6, wherein the quality score for the variant is based at least in part on an evaluation score generated by application of a visual language model to the evaluation data generating using the variant and the data generated using the control configuration.

8. The method of claim 1, wherein generating data in response to a user interaction using one of the selected subset of variants comprises generating a different user interface than when generating data in response to a user interaction using the control configuration.

9. The method of claim 1, wherein executing the software process that performs an experiment on the selected subset of variants comprises performing an A/B test between one or more of the selected subset of variants and the control configuration.

10. The method of claim 1, wherein executing the software process that performs an experiment on the selected subset of variants comprises performing a multi-arm bandit test using the selected subset of variants and the control configuration.

11. A computer program product comprising a non-transitory computer readable storage medium having instructions encoded thereon that, when executed by a processor, cause the processor to perform steps comprising:
retrieving historical interactions by users with a computer system, the computer system generating data in response to the historical interactions using a control configuration;
generating a set of variants, each variant having one or more differences from the control configuration;
generating evaluation data for each variant, wherein the evaluation data for each variant is generated by simulating the computer system to generate the evaluation data in response to the historical interactions using the variant;
generating a quality score for each variant, wherein the quality score for each variant measures a difference between the evaluation data generating using the variant and the data generated using the control configuration;
pruning one or more of the variants to select a subset of variants for testing, wherein the one or more variants are pruned by applying one or more criteria to the quality scores; and
executing a software process that performs an experiment on the selected subset of variants, wherein the experiment causes the computer system to generate data in response to additional interactions received from users based on the selected subset of variants and the control configuration, and evaluate the selected variants based on the interactions.

12. The computer program product of claim 11, wherein generating the quality score for each variant comprises:
generating text describing one or more visual features for the variant by applying a visual language model to the evaluation data generating using the variant and the data generated using the control configuration;
generating one or more metrics based on differences between the evaluation data generating using the variant and the data generated using the control configuration; and
generating the quality score for the variant based on the one or more visual features and the one or more metrics.

13. The computer program product of claim 12, wherein generating text describing one or more visual features for the variant by applying the visual language model to the evaluation data generating using the variant and the data generated using the control configuration comprises:
generating, by the visual language model, an evaluation score based on changes between the evaluation data generated using the variant and the data generated using the control configuration.

14. The computer program product of claim 13, wherein pruning one or more of the variants to select the subset of variants for testing comprises:
for a particular variant, in response to the evaluation score being less than a threshold evaluation score and one or more of the metrics being less than a corresponding threshold value, pruning the particular variant.

15. The computer program product of claim 12, wherein pruning one or more of the variants to select the subset of variants for testing comprises:
for a particular variant, in response to the one or more of the metrics being less than a threshold value, pruning the particular variant.

16. The computer program product of claim 11, wherein pruning one or more of the variants to select the subset of variants for testing comprises, for each variant:
generating a score for the variant based on the quality score for the variant by applying an assessment model to the quality score for the variant, wherein the assessment model is a machine learning model trained by:
obtaining a training dataset including a plurality of training examples, each training example including a training variant and a training quality score, each training example having a label indicating whether the training variant was used to generate data in response to interactions from users;
applying the assessment model to each training example of the training dataset to generate a predicted probability of using the training variant to generate data in response to interactions from users;
scoring the assessment model using a loss function applied to the predicted probability of using the training variant to generate data in response to interactions from users and the label of the training example; and
updating one or more parameters of the assessment model by backpropagation based on the scoring until one or more criteria are satisfied; and
in response to the predicted probability being less than a threshold probability, pruning the variant.

17. The computer program product of claim 16, wherein the quality score for the variant is based at least in part on an evaluation score generated by application of a visual language model to the evaluation data generating using the variant and the data generated using the control configuration.

18. The computer program product of claim 11, wherein generating data in response to a user interaction using one of the selected subset of variants comprises generating a different user interface than when generating data in response to a user interaction using the control configuration.

19. The computer program product of claim 11, wherein executing the software process that performs an experiment on the selected subset of variants comprises performing one of: an A/B test between one or more of the selected subset of variants and the control configuration, and a multi-arm bandit test using the selected subset of variants and the control configuration.

20. A computer system comprising:
a processor; and
a non-transitory computer readable storage medium having instructions encoded thereon that, when executed by the processor, cause the processor to perform steps comprising:
retrieving historical interactions by users with the computer system, the computer system generating data in response to the historical interactions using a control configuration;
generating a set of variants, each variant having one or more differences from the control configuration;
generating evaluation data for each variant, wherein the evaluation data for each variant is generated by simulating the computer system to generate the evaluation data in response to the historical interactions using the variant;
generating a quality score for each variant, wherein the quality score for each variant measures a difference between the evaluation data generating using the variant and the data generated using the control configuration;
pruning one or more of the variants to select a subset of variants for testing, wherein the one or more variants are pruned by applying one or more criteria to the quality scores; and
executing a software process that performs an experiment on the selected subset of variants, wherein the experiment causes the computer system to generate data in response to additional interactions received from users based on the selected subset of variants and the control configuration, and evaluate the selected variants based on the interactions.
